(19) United States
(12) Patent Application Publication
(10) Pub. No.: US 2005/0111936 A1
(43) Pub. Date: May 26, 2005

(54) Multi-chamber system

(76) Inventors: Ki-Sang Kim, Yongin-si (KR); Seung-Ki Chae, Seoul (KR); In-Ho Lee, Suwon-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 10/936,651

(22) Filed: Sep. 9, 2004

(30) Foreign Application Priority Data
Nov. 10, 2003 (KR) 2003-79160

(51) Int. Cl. B65G 1/00

(52) U.S. Cl. 414/217

(57) ABSTRACT

A multi-chamber system includes an index station at which one or more substrate cassettes are placed, a transfer passageway having one end adjacent the index station, at least one process chamber disposed alongside the transfer passageway, and at least one substrate transfer robot disposed in the transfer passageway for receiving a substrate from the index station and by which the substrate is transferred to each process chamber. The multi-chamber system has a minimal footprint. Furthermore, the system can be easily expanded. In addition, the substrate transfer robot(s) may have a blade including two substrate supports so that the time required for moving a substrate through the system is minimized.

### BACKGROUND OF THE INVENTION

1. Field of the Invention

The present invention is directed to a multi-chamber system for manufacturing semiconductor devices.

2. Description of the Related Art

In general, a cluster system is a multi-chamber type of apparatus that includes a transfer robot (or handler) and a plurality of processing modules disposed around the transfer robot. Today, there is an increasing demand for cluster systems that can execute a plurality of processes in the manufacturing of semiconductor devices and the like.

For instance, a cluster system is used to dry etch semiconductor wafers with plasma. This cluster system comprises a plurality of process chambers in which a high vacuum environment, necessary for creating the plasma, is maintained. The cluster system also includes a centralized transfer chamber in which a transfer apparatus is disposed. The transfer apparatus is operative to load/unload wafers to/from the process chambers.

A conventional multi-chamber system 10 of an etch facility is illustrated in FIG. 23. The multi-chamber system 10 has a six-sided (hexagonal) central chamber 16 and four process chambers 15 connected to respective sides of the central chamber 16. A process is carried out on a wafer in each of the respective process chambers 15. Two loadlock chambers 13 are connected to the remaining two sides of the central chamber 16, respectively.

The central chamber 16 of the multi-chamber system 10 occupies a large area as it accommodate six modules (the four process chambers and the two loadlock chambers) on respective sides thereof. Accordingly, the entire area of the facility is rather large and, in particular, the vacuum facility for maintaining a vacuum in the chambers must be correspondingly large and complex. Of course, the large scale of the facility is responsible for high equipment and installation costs.

As the number of process chambers 15 increases, the area of the central chamber 16 must also increase. For example, if the multi-chamber system is to employ six process chambers, the central chamber must be octagonal. In this case, the central chamber would have a much larger area than if only four process chambers were employed. Therefore, if the facility requires an increase in the number of process chambers 15, an additional centralized multi-chamber system is installed in the facility.

However, multi-chamber systems have very high purchase prices and installation costs. Also, an additional multi-chamber system would occupy a rather large area. In the case in which an additional multi-chamber system is added to the facility, the footprint of the multi-chamber systems would occupy a significantly large part of the clean room of the facility. Furthermore, various components of the vacuum system and of the system for supplying gas to the process chambers and/or loadlock chambers would be duplicated.

Moreover, the transfer apparatus transfers of the conventional cluster system transfers only one substrate at a time. For example, the transfer apparatus may carry a processed substrate from a process chamber to a loadlock chamber (or another process chamber) while another substrate coming from the loadlock chamber is held before it is transferred to the process chamber.

These operations of the transfer apparatus, required for processing a substrate in the system, require long amounts of time. Thus, the conventional transfer apparatus impedes the production rate and, as such, contributes to the high cost of the completed products.

### SUMMARY OF THE INVENTION

An object of the present invention is to provide a multi-chamber system that occupies very little space within a manufacturing facility.

Another object of the invention is to provide a multi-chamber system which minimizes the compartmental areas in which a vacuum must be maintained, thereby minimizing equipment and operating costs.

Still another object of the invention is to provide a multi-chamber system that can be readily expanded.

Furthermore, another object of the invention is to provide a multi-chamber system that minimizes the time required to move a substrate through the system while being processed.

A multi-chamber system of the present invention comprises an index station on which one or more substrate cassettes are placed, a transfer passageway that is just wide enough to accommodate the transfer of a substrate therealong, at least one process chamber disposed alongside the transfer passageway, and substrate transfer apparatus disposed in the transfer passageway for receiving a substrate from the index station and by which the substrates are transferred to/from the process chambers.

According to one aspect of the present invention, the index station may include a single substrate transfer robot having a working envelope that encompasses a substrate unloading position and is operative to remove substrates from a cassette disposed at the unloading position. In this case, the substrate transfer apparatus comprises a first transfer robot having a working envelope that encompasses the working envelope of the single substrate transfer robot and at least one of the process chambers disposed alongside the transfer passageway. Thus, the first transfer robot is operative to receive a substrate directly from the single substrate transfer robot, to load the received substrate into at least one process chamber, and to unload a substrate from at least one process chamber.

The substrate transfer apparatus may also comprises a second transfer robot disposed in line with the first transfer robot. In this case, the second transfer robot has a working envelope that encompasses that of the first transfer robot and at least one process chamber disposed at the side of the transfer passageway. Thus, the second transfer robot is operative to receive a substrate directly from the first transfer robot, to load a substrate received from the first transfer robot into at least one process chamber, and to unload a substrate from at least one process chamber.

On the other hand, a substrate station maybe interposed between the first and second transfer robots. The substrate station includes a substrate support configured to support a substrate. The substrate support may comprise a base, and a lifting device for lifting and lowering a substrate off of and onto the base. In this case, the working envelopes of each of the first and second transfer robots encompass the substrate station. Accordingly, substrates are transferred indirectly between the first and second transfer robots via the substrate station.

Also, open spaces are left on opposite sides of the transfer passageway at the location of the substrate station. The open spaces define service areas that allow at least one said process chamber to be checked.

Alternatively, and according to one aspect of the present invention, at least one loadlock chamber is connected to the transfer passageway as interposed between and directly connected to a plurality of the process chambers so as to be shared by the process chambers. In this case, the substrate transfer apparatus disposed in the transfer passageway has a working envelope encompassing the unloading position of the index station and each loadlock chamber. Thus, the substrate transfer apparatus is operative to receive a substrate from the index station, to load the received substrate into the loadlock chamber, and to unload a substrate from the loadlock chamber. A second substrate transfer robot is disposed in the loadlock chamber. The second transfer robot has a working envelope encompassing the working envelope of the substrate transfer apparatus and a plurality of process chambers. Thus, the second substrate transfer robot is operative to receive a substrate from the substrate transfer apparatus, to load the received substrate into any of a plurality of process chambers, and to unload a processed substrate from any of a plurality process chambers.

According to yet another aspect of the present invention, one or more of the substrate transfer robots comprises a base, a first arm having a rear end connected to the base and supported so as to be rotatable in a horizontal plane, a second arm having a rear end connected to a front end of the first arm and supported so as to be rotatable in a horizontal plane, and a blade connected to the front end of the second arm and supported so as to be rotatable in a horizontal plane. The blade has at least two substrate supports configured to respectively support substrates in the same plane. Preferably, the substrate supports are C-shaped or are linear and elongate for supporting the bottom of a substrate.

Also, one or more of the substrate transfer robots comprises an elevator for moving the blade thereof up and down. In the case in which the first and second substrate transfer robots are disposed in-line in the transfer passageway, the elevator and the different shapes of the substrate supports allow the first and second substrate transfer robots to directly transfer a substrate therebetween.

### BRIEF DESCRIPTION OF THE DRAWINGS

FIG. 1 is a plan view of a first embodiment of a multi-chamber processing system according to the present invention.

FIG. 2 is a perspective view of a part of the multi-chamber processing system comprising transfer robots and some of the process chambers.

FIG. 3 is a side view of a first robot of the multi-chamber processing system.

FIG. 4 is a cross-sectional view of a power delivery system of the first robot.

FIG. 5 through FIG. 8 are top plan views of the multi-chamber processing system, showing the steps of loading a substrate into a process chamber.

FIG. 9 through FIG. 14 are plan views of the multi-chamber processing system, showing the steps of exchanging a substrate awaiting processing for a completely processed substrate.

FIG. 15 through FIG. 17 are plan views of the multi-chamber processing system, showing the steps of transferring a substrate from the first robot to a second robot of the system.

FIG. 18 is a side view of the first and second robots, showing the steps of transferring a substrate from the first robot to the second robot.

FIG. 19 is a plan view of a second embodiment of a multi-chamber system according to the present invention.

FIG. 20(a)-(f) are each a plan view of an embodiment of a multi-chamber system according to the present invention.

FIG. 21 is a plan view of various other multi-chamber systems according to the present invention.

FIG. 22 is a plan view of a third embodiment of a multi-chamber system according to the present invention.

FIG. 23 is a plan view of a conventional multi-chamber system of an etch facility for manufacturing semiconductor devices.

### DETAILED DESCRIPTION OF THE INVENTION

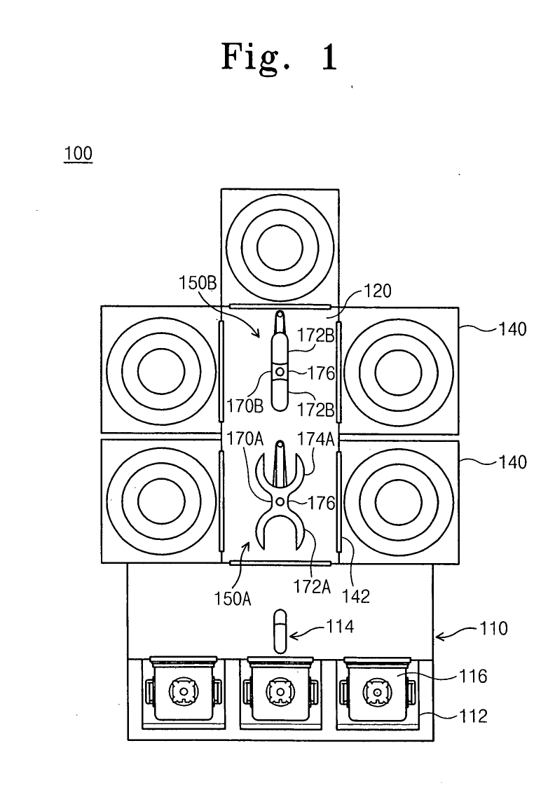

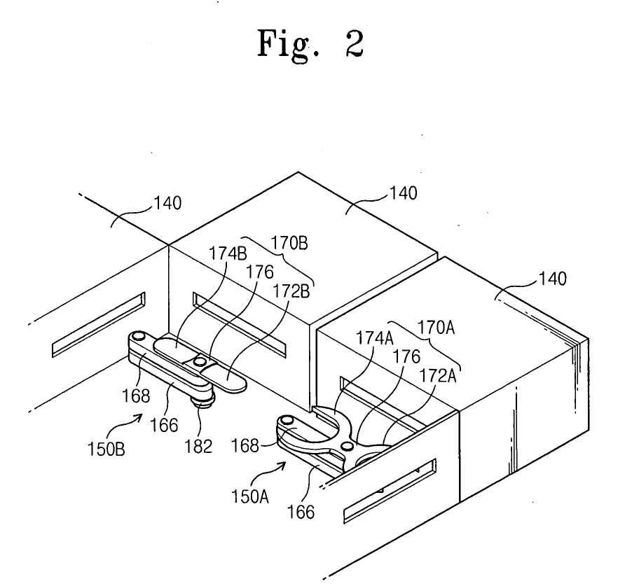

Referring to FIG. 1 and FIG. 2, a first embodiment of a multi-chamber system 100 according the present invention includes an index station 110, a transfer passageway 120, five process chambers 140 connected to the transfer passageway 120, and dual substrate transfer apparatus comprising a first robot 150A and a second robot 150B disposed in the transfer passageway 120.

The index station 110 may comprise an equipment front end module (EFEM) having FOUP openers 112 and a single substrate transfer robot 114. Three front opening unified pods (FOUPs) 116 are mounted on the FOUP openers 112 of the index station 110, respectively. FOUPs are typically used as substrate carriers in mass production and can be installed at the index station 110 by means of an automatic transport system, e.g., an overhead hoist transport (OHT) vehicle, automatic guided vehicle (AGV), or rail guided vehicle (RGV). The index station 110 is connected to one end of the transfer passageway 120.

The first robot 150A is disposed adjacent to the index station 110, and the second robot 150B is disposed adjacent three of the process chambers 140. The first robot 150A may directly transfer a substrate to either the single substrate transfer robot 114 or the second robot 150B. To this end, the second robot 150B has a straight blade corresponding to that of the single substrate transfer robot 114, and the first robot 150A has a C-shaped blade into which the straight blade of the second robot 150B can be inserted. Furthermore, the first robot 1 50A has an elevator for moving the C-shaped blade up and down. The second robot 150B transfers a substrate between three of the process chambers 140.

The process chambers 140 may execute any of various substrate processing operations. For example, the process chambers may comprise a CVD apparatus for forming an insulation layer on a substrate, an etch apparatus for etching apertures or openings in a substrate that are used to form interconnect structures, or a PVD apparatus for forming a barrier layer or a metal layer on a substrate. A number of such processing apparatuses, needed to perform all of the processes for fabricating an integrated circuit or chip, may be provided. Note, however, that the multi-chamber systems of the present invention can be applied to facilities other than those for fabricating semiconductor devices, such as those for fabricating liquid crystal displays (LCD), and plasma display devices, or the like.

Each of the respective process chambers 140 has a first gate 142. The first gate 142 is selectively openable and closable for allowing a substrate to pass from the transfer passageway 120 into the process chamber 140 and vice versa. The gate 142 is a slit valve, which is well known in the art and will not be described in further detail.

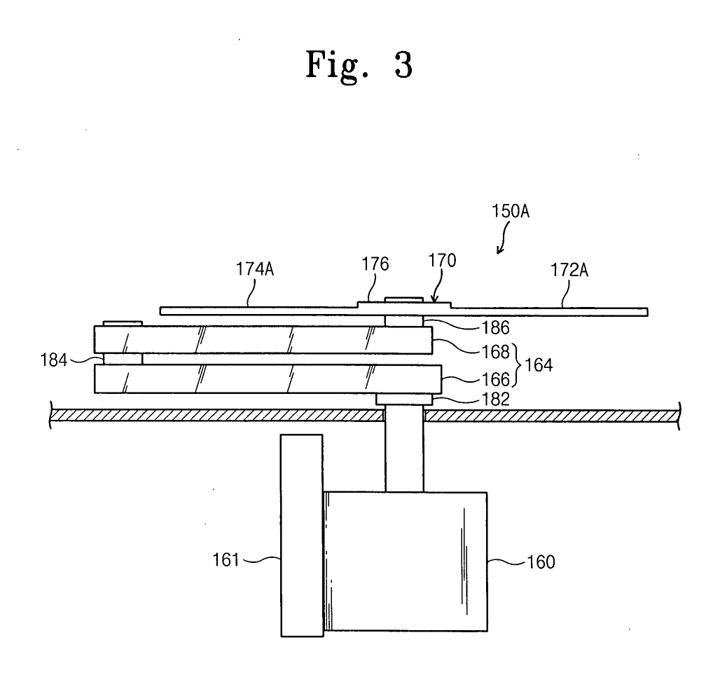

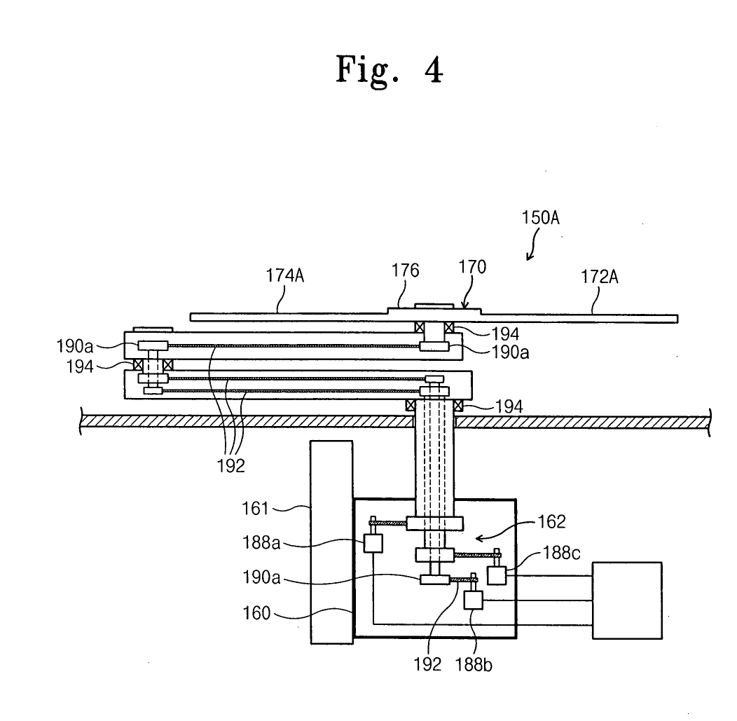

The first and second robots 155A and 150B will now be described more fully hereinafter with reference to FIGS. 1-4. However, the first and second robots 150A and 150B have the same structure except for the shape of their blades. Accordingly, the second robot 150B will not be described in specific detail.

The first robot 150A includes a dual blade 170A having two substrate supports 172A and 174A that perform a carry-in operation and a carry-out operation. The carry-in operation is an operation in which a substrate is received from the single substrate transfer apparatus 114, and is carried into a process chamber 140. The carry-out operation is an operation in which a completely processed substrate is carried out from a process chamber 140.

Advantageously, the first robot 150A may transfer a substrate from and between two process chambers within a narrow area. As will be more evident form the description that follows, this is accomplished by extending an arm of the robot without rotating the robot at its base. Furthermore, the first robot 150A may be employed in a very small sized loadlock chamber despite the fact that it comprises two substrate supports.

Referring now to FIG. 2 through FIG. 4, the first robot 150A is a multi-jointed frog-leg type of robot having a base 160 comprising an arm actuator 162, an arm unit 164 including a first arm 166 and a second arm 168, and the dual blade 170A. The first and second arms 166 and 168 are connected to the arm actuator 162 so as to each be rotatable in a horizontal plane. Note, that the first substrate support 172A and the second substrate support 174A of the dual blade 170A support two substrates, respectively, in the same plane. The dual blade 170A also has a fixture 176 connected to a third joint 186 disposed on an end of the second arm 168. The substrate supports 172A and 174A are disposed on opposite sides of the fixture 176. Each substrate support is C-shaped so that it supports the bottom of a substrate along an outer peripheral part thereof. The single substrate transfer apparatus 114 and the second robot 150B each have a straight blade that will not interfere with the C-shaped wafer supports 172A, 174A of the dual blade 170A while a substrate is being transferred from either the single substrate transfer apparatus 114 or the second robot 150B to the first robot 150A. Also, a chuck may also be installed on the blade 170A for securing a substrate to the blade. The chuck may be a vacuum line through which a vacuum can be exerted on the substrate or a clamp for mechanically clamping an edge of a substrate to the blade.

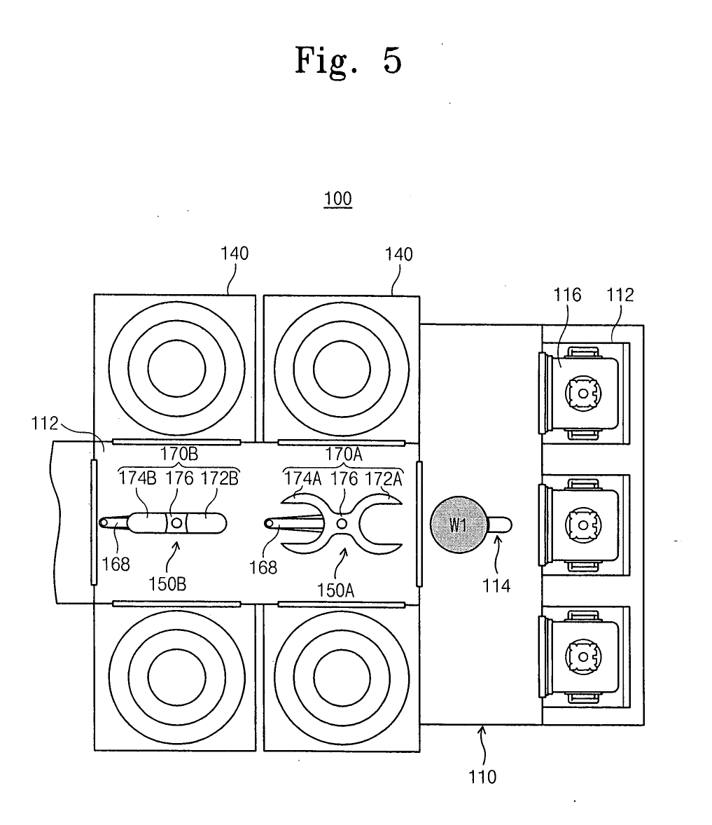

The first, second and third joints 182, 184 and 186 of the dual wafer transfer apparatus 150A are respectively controlled by driving motors 188a, 188b and 188c of the actuator disposed in the base 160. The joints 182, 184 and 186 are connected to the driving motors through a transmission mechanism. As an example, the transmission mechanism comprises one or more pulleys 190a and belts 192 connected to bearings 194. Preferably, the driving motors 188a, 188b and 188c are independently controllable to independently control the rotation of the first arm 166 about the rear end thereof, the second arm 168 about the rear end thereof, and the blade 170 about the fixture 176 thereof so that the arm unit 164 can be moved between a fully retracted position (FIG. 5) and an extended position. Note, although two driving motors are being shown and described as controlling the relative rotations of the first and second arms 166, 168, respectively, a single driving motor (188a) can be used to control the rotations of the first arm and second arms 166, 168. Also, an elevator 161 is connected to the base 160 for moving the arm unit 164 up and down.

The first joint 182 connects the base 160 with the first arm 166. The second joint 184 connects the first arm 166 with the second arm 168. The third joint 186 connects the second arm 168 with the blade 170. Each of the joints 182, 184 and 186 comprises a bearing 194 connected to the transmission mechanism such that each joint receives power from a respective one of the driving motors 188a, 188b and 188c.

The driving motors 188a, 188b and 188c of the dual wafer transfer apparatus 150 are programmed, according to kinematic equations of the arm unit 164, to position the arms 166, 168 and blade 170 at desired locations. The program can be stored in a data memory device of a microprocessor (programmable controller) that provides signals for operating the driving motors 188a, 188b and 188c.

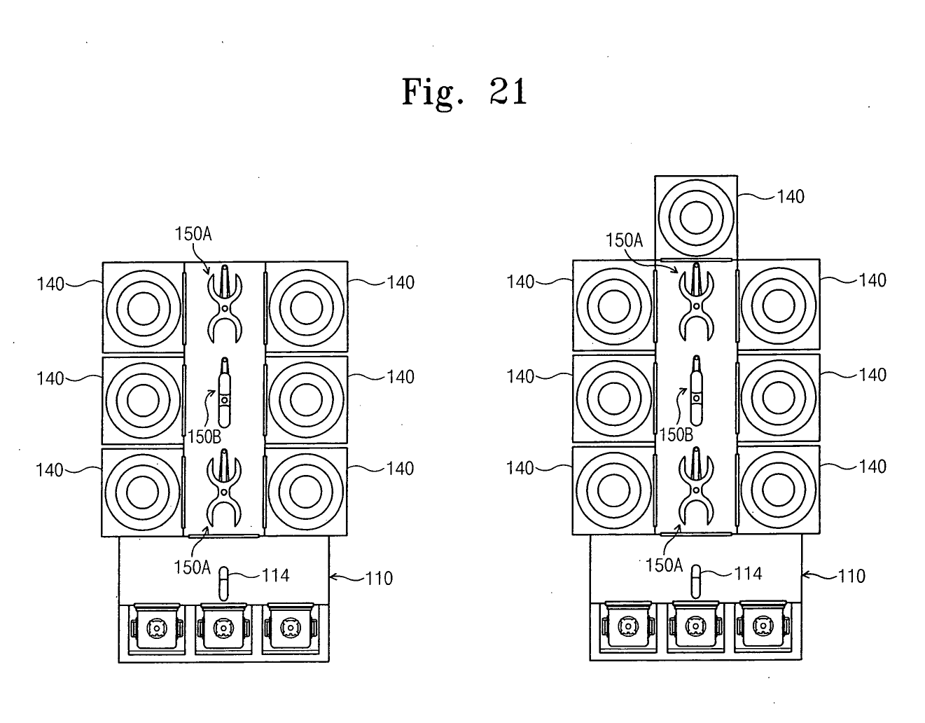

The multi-chamber system 100 can be enlarged by extending the transfer passage 120, installing an additional dual substrate transfer robot 150A at the end of the extended transfer passage 120, and installing at least one new process chamber adjacent the newly installed robot, as shown in FIG. 21. As is clear from this figure, the multi-chamber system 100 makes it easier to add a process chamber than a conventional centralized multi-chamber system. Also, the multi-chamber system 100 is both narrower and shorter than a comparable conventional centralized multi-chamber system, i.e., is more compact. Thus, the multi-chamber system 100 according to the present invention takes up less area in the manufacturing facility.

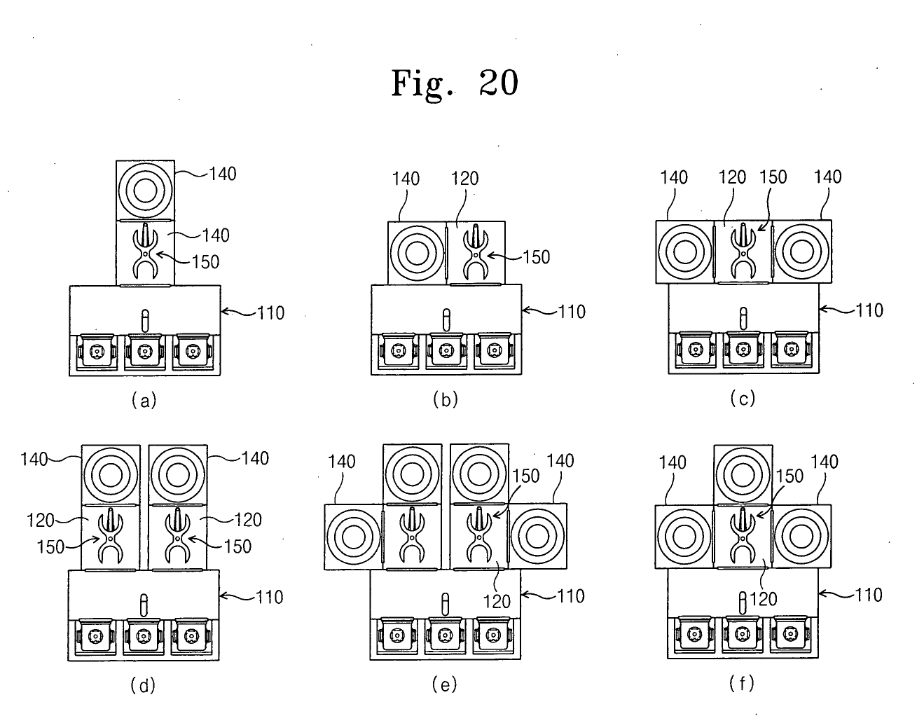

Although the present invention has been described so far as comprising two substrate transfer robots installed in the transfer passageway 120 and five or more process chambers connected to the transfer passageway 120, the present invention is not so limited. Rather, the multi-chamber system according to the present invention may have various configurations as illustrated in FIGS. 20(a)-20(f). For example, the multi-chamber system according to the present invention may comprise only one substrate transfer robot 150 in the transfer passageway 120, and one to three process chambers 140 disposed around the transfer passageway 120, as shown in FIGS. 20(a)-20(c) and 20(f). Alternatively, the multi-chamber system according to the present invention may comprise two transfer passageways 120 in which respective substrate transfers robots 150 are disposed, and one or two process chambers 140 disposed around each transfer passageway 120, as shown in FIGS. 20(d) and 20(e).

The operation of the multi-chamber system 100 of FIG. 1 will now be described.

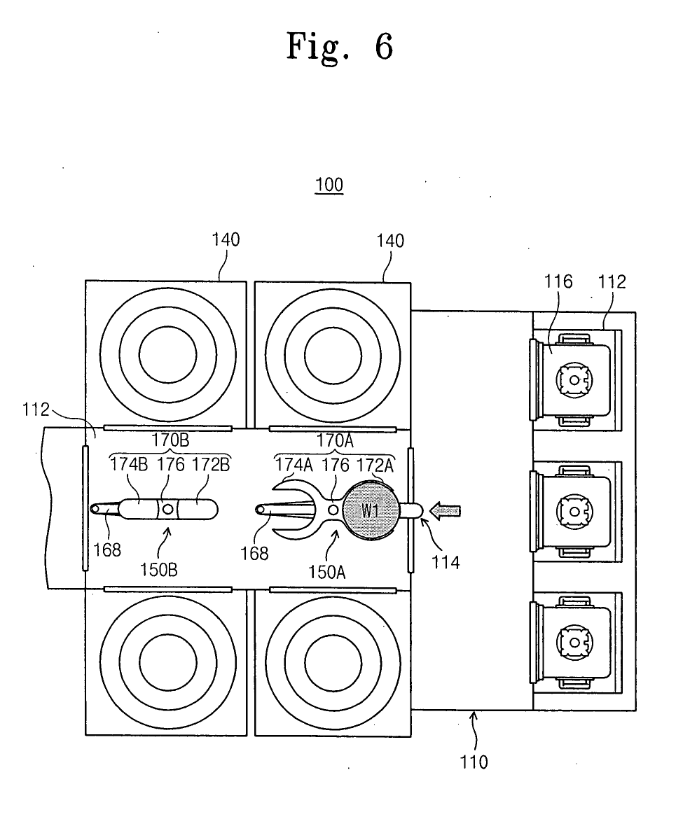

The loading of a substrate into a process chamber 140 by the first robot 150A will now be described with reference to FIG. 5 through FIG. 8. As shown in FIG. 5, the first robot 150A starts from a completely retracted position (standby position) in which the first and second arms 166 and 168 and the blade 170A are aligned in the same direction. Next, as shown in FIG. 6, a substrate W1 is placed on the first support 172a of the blade 170A adjacent the index station 110 by the single substrate transfer apparatus 114.

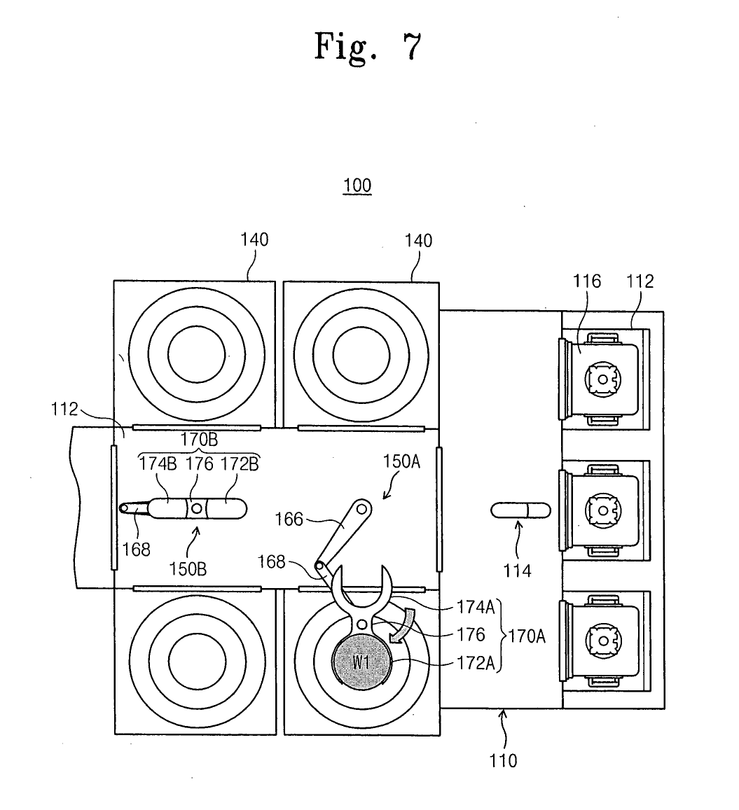

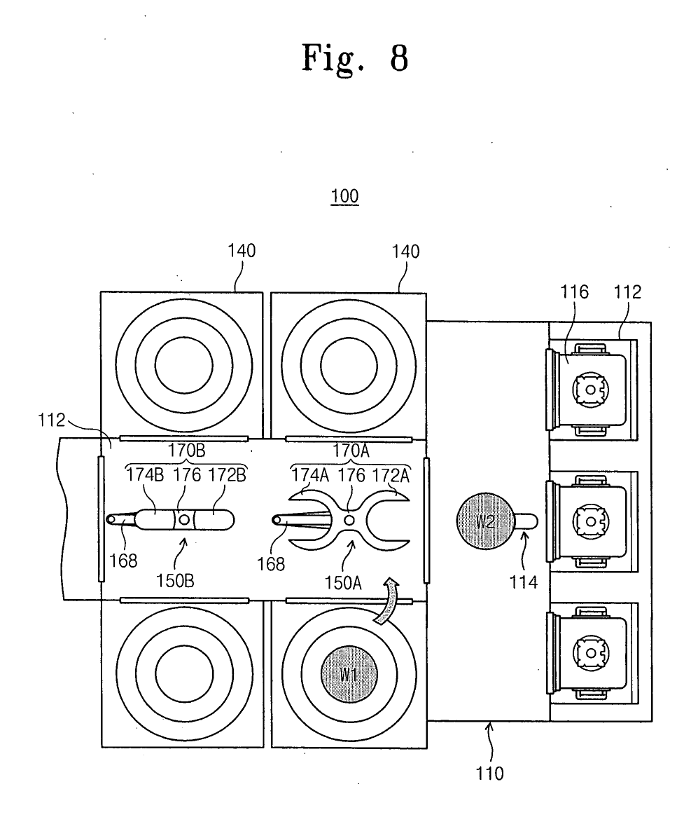

The arms 166, 168 are extended to the positions shown in FIG. 7 and the blade 170A is rotated a predetermined angle so that the first robot 150A places the substrate W1 at a loading position in a process chamber 140. The substrate WI may be lifted from the first support 172A in the process chamber 140 by means of a substrate lifting device (a typical device having three lift pins—not shown). Next, the first robot 150A is completely retracted to the standby position outside of the process chamber 140, as shown in FIG. 8. The substrate W1 is then set on a substrate stage of the process chamber 140 (by lowering the lift pins) or is otherwise prepared for processing in the process chamber 140.

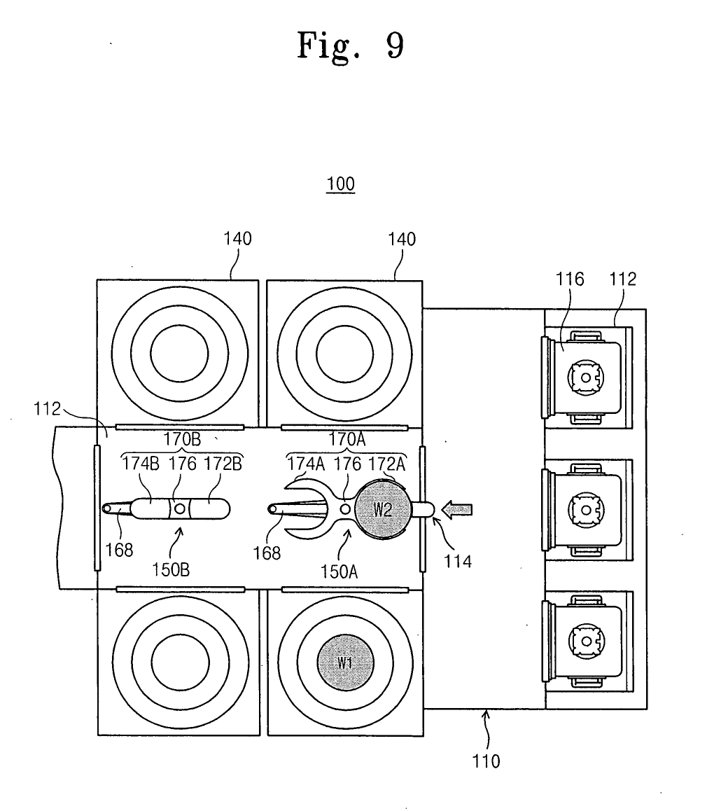

The exchanging of an unprocessed substrate with a processed substrate will now be described with reference to FIG. 9 through FIG. 14.

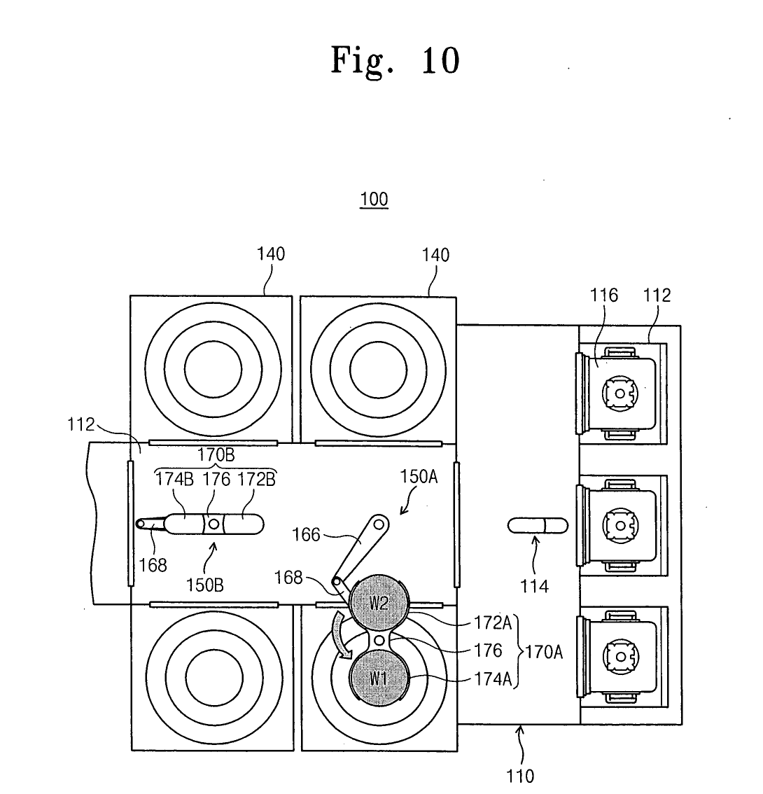

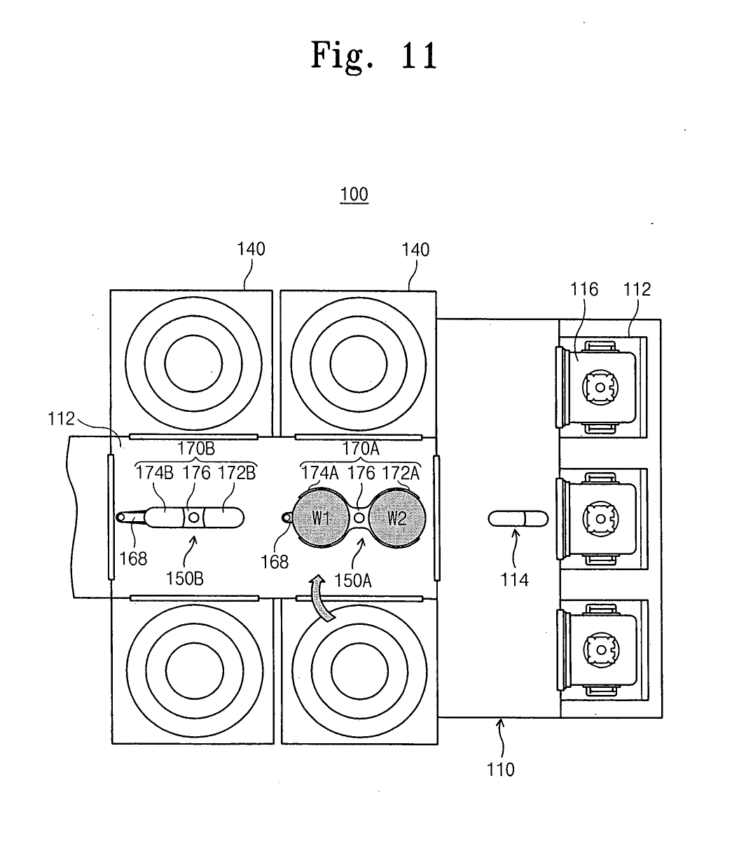

An unprocessed substrate W2 is placed the first substrate support 172A of the blade 170A by the single substrate transfer apparatus 114. Once the substrate WI has been processed in the process chamber 140, the first gate 142 leading into the chamber 140 is opened and the second support 174A of the blade 170A is extended through the first gate 142 to the position shown in FIG. 10. Then, the processed substrate W1 is placed on the second support 174A by the substrate lift device (not shown), and the first robot 150A is retracted to the standby position within the transfer passageway 120, as shown in FIG. 11.

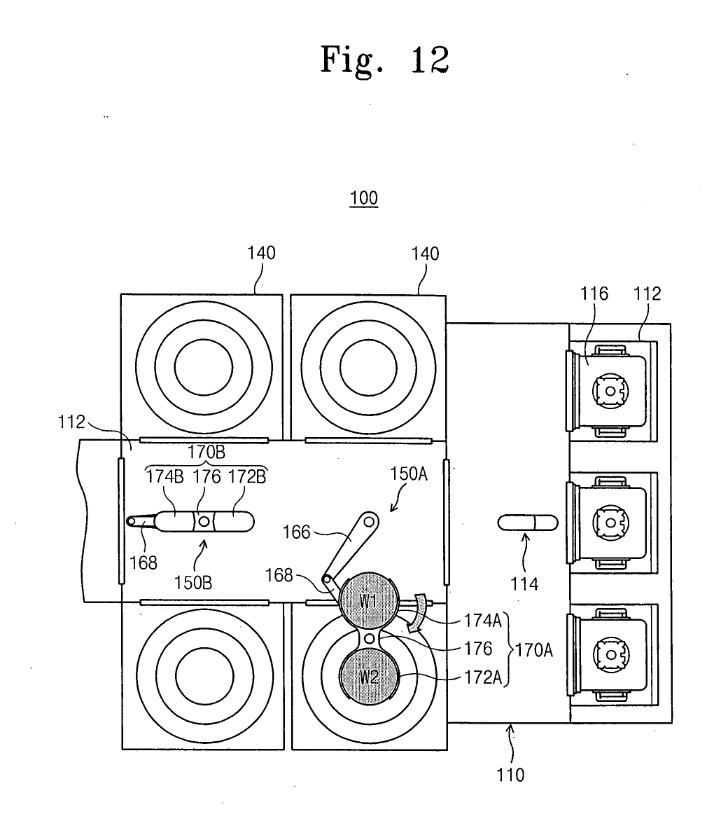

Next, the arms of the first robot 150A are extended to the position shown in FIG. 12 and the blade 170A is rotated such that the first robot 150A places the unprocessed substrate W2 at the loading position in the process chamber 140. The substrate W2 may be lifted from the first support 172A by the substrate lifting device of the process chamber.

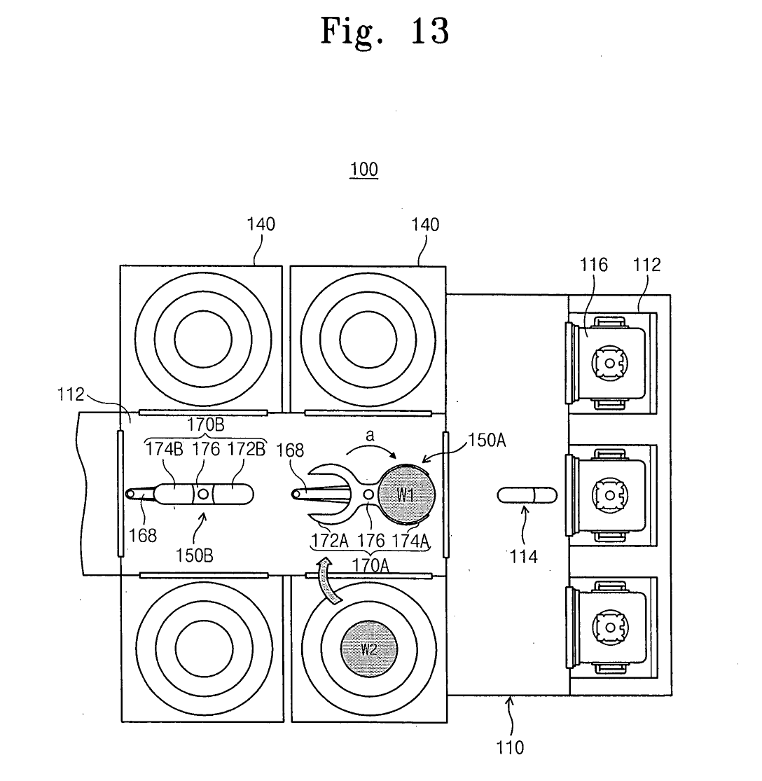

Again, the first robot 150A is retracted to the standby position, as shown in FIG. 13. Note, however, that as the arms are retracted the blade 170A is rotated in reverse (in the clockwise direction (a) in the figure) to position the second support 174A adjacent the index station 110. More specifically, the blade 170A is rotated 180 degrees, so that the processed substrate W1 is located at an unloading position facing the index station 110.

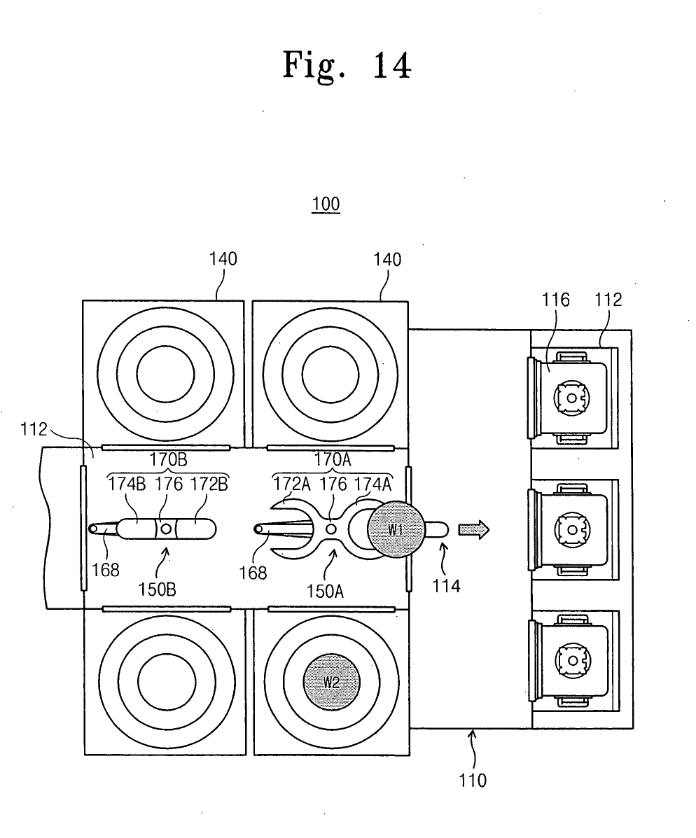

Finally, the processed substrate WI is delivered to the single substrate transfer apparatus 114 (FIG. 14). From there, the processed substrate WI is unloaded from the single substrate transfer apparatus 114 into a FOUP 116.

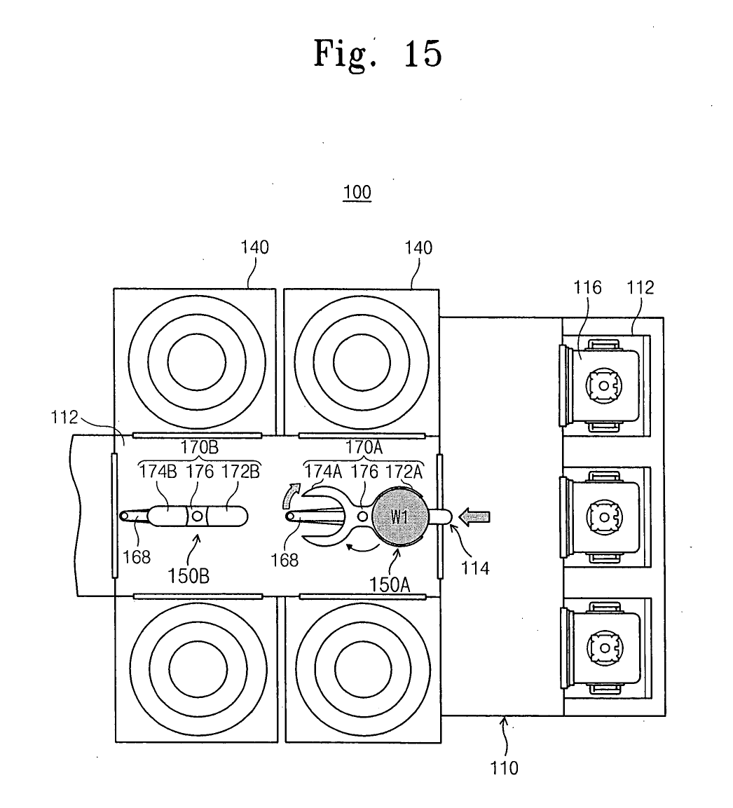

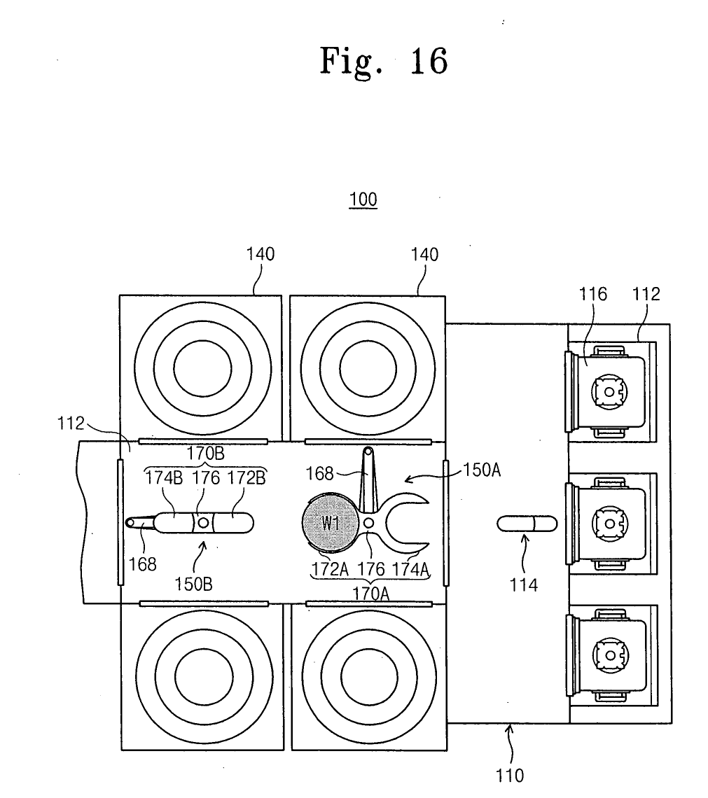

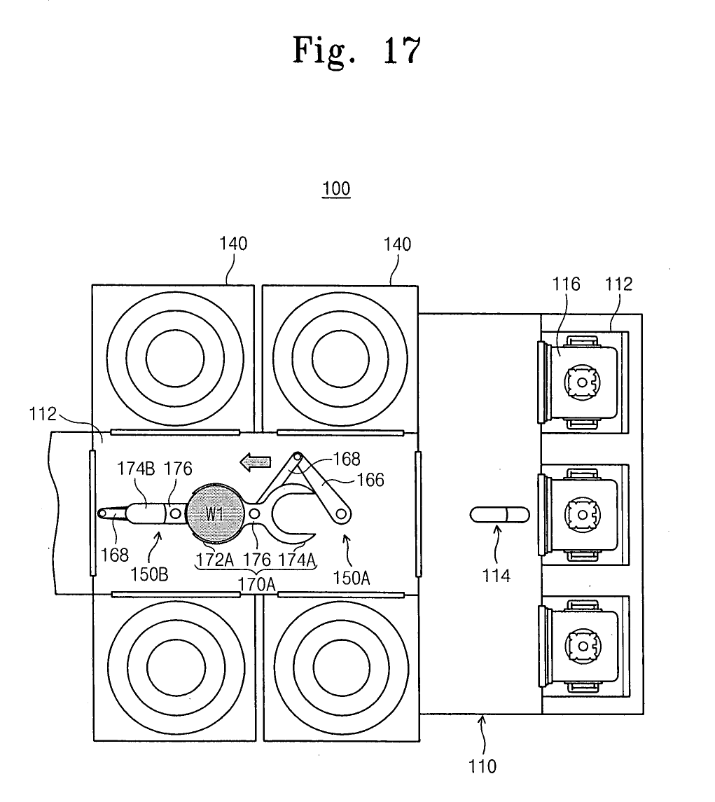

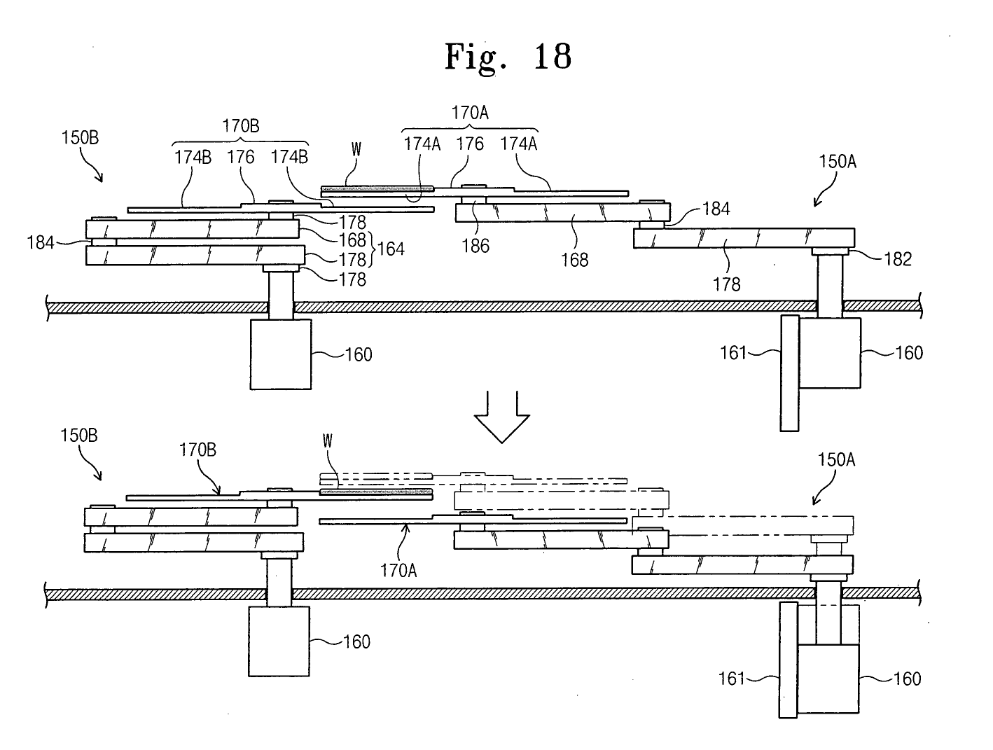

The transferring of a substrate from the first robot to a second robot will now be described with reference to FIG. 15 through FIG. 18. A substrate W1 is placed on the first support 172A of the first robot 150A adjacent the index station by the single substrate transfer apparatus 114 (FIG. 15). The blade 170A is rotated 180 degrees such that the substrate W1 is disposed adjacent the second robot 150B. At that time, arm unit 164 is rotated clockwise to the position shown in FIG. 16. The arms 166, 168 of the first robot 150A are then extended such that the first support 172A of the first robot 150A is disposed over the first support 172B of the second robot 150B, as shown in FIG. 17. Then the arm unit 164 of the first robot 150A is moved down by the elevator 161 to insert the first support 172B of the second robot 150B within the first support 172A of the first robot 150A and thereby receive the substrate W1 (FIG. 18). Obviously, the transferring of the substrate from the second robot 150B to the first robot 150A is carried out in a manner similar to that described above.

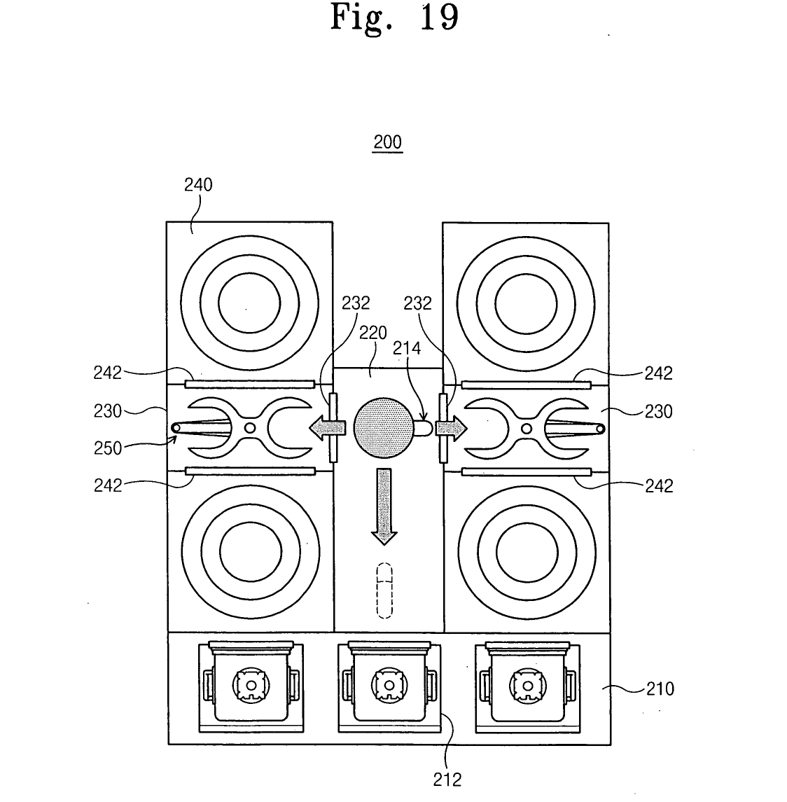

A second embodiment of a multi-chamber system 200 according to the present invention is illustrated in FIG. 19. The multi-chamber system 200 includes an index station 210, a transfer passageway 220, process chambers 240, and dual substrate transfer apparatuses 250 each of which has the same structure and function as that of the first embodiment of FIG. 1. However, in the second embodiment, a single substrate transfer apparatus 214 for loading/unloading a substrate into/from a FOUP is installed in the transfer passageway 220. Alternatively, a dual transfer apparatus can be used in place of the single substrate transfer apparatus 214. One end of the transfer passageway 220 abuts the index station 210. A plurality of FOUPs are disposed on respective FOUP openers 212 of the index station 210.

Furthermore, the multi-chamber system 200 includes vacuum loadlock chambers 230 connected to both sides of the transfer passageway 220, and vacuum process chambers 240 connected to each of the loadlock chambers 230. A dual substrate transfer apparatus 250 is disposed in each loadlock chamber 230.

More specifically, each loadlock chamber 230 is connected to two respective process chambers 240 so as to be shared thereby. The loadlock chamber 230 allows a substrate to move between the transfer passageway 220 and the process chambers 240 while ultra-high vacuum conditions are maintained in the process chambers 240. The dual substrate transfer apparatus 250 can transfer a substrate between the transfer passageway 220 and the two process chambers 240 connected to the loadlock chamber in which the apparatus 250 is disposed. Although this embodiment has been described as having a loadlock chamber shared by only two process chambers, the present invention is not so limited. Rather, each loadlock chamber can be shared by three or more process chambers.

In any case, each loadlock chamber 230 has a first gate 232. The first gate 232 is selectively openable and closable for allowing a substrate to pass in and out of the loadlock chamber 230 between the loadlock chamber 230 and the transfer passageway 220. Each process chamber 240 has second gate 242. The second gate 242 is selectively openable and closable for allowing a substrate to pass between the loadlock chamber 230 and the process chamber 240. The gates 232 and 242 are slit valves comprising slots, which are well known in the art and will not be described in further detail. When the second gate 242 is opened to allow a substrate to be transferred between the loadlock chamber 230 and the process chamber 240, a vacuum generating device (not shown) connected to the loadlock chamber 230 creates a vacuum in the loadlock chamber 230 to prevent a rapid pressure change from occurring in the process chamber 240. The vacuum pressure generating device is a well known device comprising a vacuum pump, and will not be described in further detail.

Each dual substrate transfer apparatus 250 installed in a loadlock chamber 230 includes a dual blade 270 having two substrate supports. The dual substrate transfer apparatus 250 can thus perform a carry-in operation in which a substrate is received from the single substrate transfer apparatus 214 and is carried into a process chamber 240. The dual substrate transfer apparatus 250 also performs a carry-out operation in which a processed substrate is carried out from the process chamber 240. Basically, each dual substrate transfer apparatus 250 has the same structure and function as the dual substrate transfer apparatus 150 of the first embodiment and will not be described in further detail.

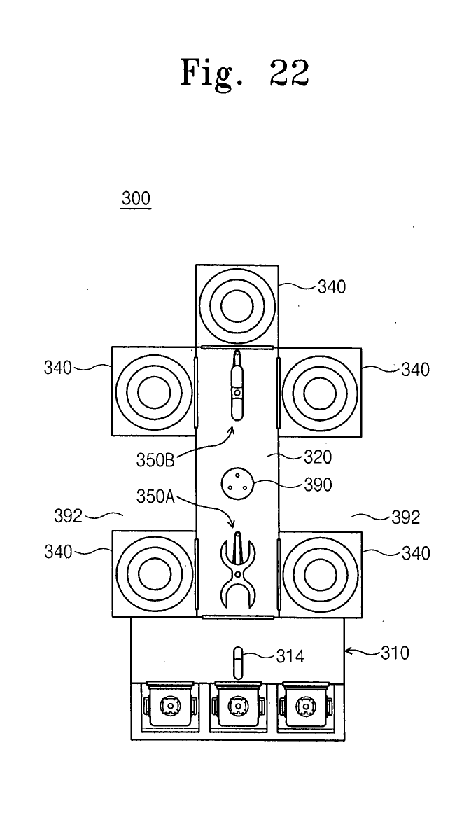

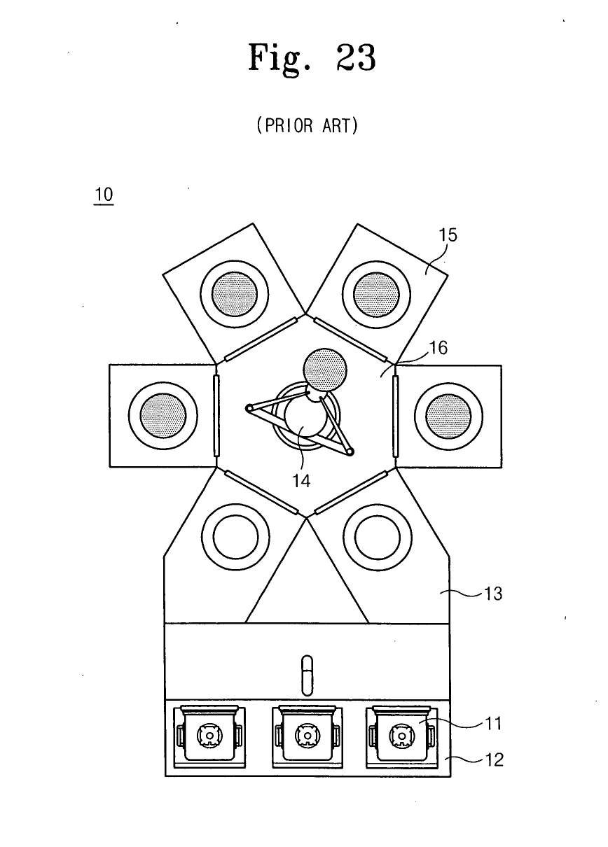

A third embodiment of a multi-chamber system 300 according to the present invention is illustrated in FIG. 22. The multi-chamber system 300 includes an index station 310, a transfer passageway 320, and dual substrate transfer apparatuses comprising first and second robots 350A and 350B, which have the same structure and function as those of the first embodiment. However, the third embodiment is characterized in that a substrate station 390 is interposed between the first and second robots 350A and 350B. A conventional substrate lift device (typical device having three lift pins) is installed at the substrate station 390. A substrate is transferred between the first and second robots 350A and 350B through the substrate station 390. The provision of the substrate station 390 in the transfer passageway 320 allows for a separate service area 392 to be offered at both sides of the transfer passageway 320 between respective ones of the process chambers 340. The service areas 392 allow the system 300 to be checked and serviced.

Finally, although the present invention has been described above in connection with the preferred embodiments thereof, modifications of the preferred embodiments will become readily apparent to those of ordinary skill in the art. It will thus be appreciated and understood, therefore, that the invention is not limited to those embodiments. Rather, the true spirit and scope of the invention is defined in the appended claims.

1. A multi-chamber system comprising:
an index station configured to support at least one substrate cassette, and comprising a single substrate transfer robot having a working envelope encompassing a substrate unloading position and operative to remove substrates from a cassette disposed at the unloading position;
a transfer passageway having a first end adjacent said index station;
at least one process chamber, in which a substrate is processed, disposed alongside said transfer passageway; and
substrate transfer apparatus disposed within said transfer passageway, said substrate transfer apparatus comprising a first transfer robot having a working envelope encompassing the working envelope of said single substrate transfer robot and at least one said process chamber disposed at a side of the transfer passageway, wherein said first transfer robot is operative to receive a substrate directly from the single substrate transfer robot, to load the received substrate into at least one said process chamber, and to unload a substrate from at least one said process chamber.

2. The multi-chamber system as recited in claim 1, wherein the first transfer robot comprises:
a base, a first arm having a rear end and a front end, the rear end being connected to said base, and said first arm being supported so as to be rotatable in a horizontal plane about said rear end thereof, a second arm having a front end and a rear end, the rear end of the second arm being connected to the front end of said first arm, and said second arm being supported so as to be rotatable in a horizontal plane, and a blade connected to the front end of said second arm and supported so as to be rotatable in a horizontal plane, said blade having at least two substrate supports configured to respectively support substrates in the same plane.

3. The multi-chamber system as recited in claimed 2, wherein the first transfer robot further comprises:
an arm actuator supporting said first arm at said rear end thereof, operatively connected to said first and second arms so as to rotate said arms about the rear ends thereof, respectively, and operatively connected to said blade so as to rotate said blade relative to said second arm,
a first joint rotatably supporting the first arm at said rear end thereof, a second joint connecting the rear end of said second arm to the front end of said first arm and rotatably supporting the second arm at said rear end thereof, a third joint connecting said blade and the front end of said second arm and rotatably supporting said blade at the front end of said second arm, and
timing pulleys timing belts connecting said arm actuator to said joints.

4. The multi-chamber system as recited in claim 3, wherein said arm actuator comprises three motors connected to said first arm, said second arm and said blade, respectively, so as. to independently rotate said first arm, said second arm and said blade at said joints, respectively.

5. The multi-chamber system as recited in claim 2, wherein the blade comprises a fixture connected to the front end of said second arm, and said substrate supports comprise a first substrate support extending from the fixture at one side thereof, and a second substrate support extending from the fixture at another side thereof, said substrate supports being disposed symmetrically with respect to said fixture.

6. The multi-chamber system as recited in claim 3, wherein said substrate supports are each C-shaped.

7. The multi-chamber system as recited in claim 1, wherein said substrate transfer apparatus comprises a second transfer robot disposed in line with said first transfer robot, said second transfer robot having a working envelope that encompasses that of said first transfer robot and at least one said process chamber disposed at a side of the transfer passageway, wherein said second transfer robot is operative to receive a substrate directly from said first transfer robot, to load a substrate received from said first transfer robot into at least one said process chamber, and to unload a substrate from at least one said process chamber.

8. The multi-chamber system as recited in claim 7, wherein each of the first and second robots has a blade comprising at least one substrate support configured to support a substrate during its transfer by the robot, and the substrate supports of said first and second robots have different shapes.

9. The multi-chamber system as recited in claim 8, wherein each said at least one substrate support of the first robot is C-shaped, and each said at least one substrate support of the second robot is linear and elongate.

10. The multi-chamber system as recited in claim 1, wherein said substrate transfer apparatus comprises a second transfer robot, and a substrate station interposed between said first and second transfer robots, said substrate station comprising a substrate support configured to support a substrate, and the working envelopes of each of said first and second transfer robots encompassing said substrate station such that substrates are transferred indirectly between said first and second transfer robots via said substrate station.

11. The multi-chamber system as recited in claim 10, wherein open spaces are left on opposite sides of the transfer passageway at the location of said substrate station, said open spaces defining service areas that allow at least one said process chamber to be checked.

12. A multi-chamber system comprising:
an index station configured to support at least one substrate cassette, and establishing an unloading position at which substrates are removed from a cassette;
a transfer passageway having a first end adjacent said index station;
a plurality of process chambers, in which a substrate is processed, disposed along at least one side said transfer passageway;
a loadlock chamber connected to the transfer passageway, the loadlock chamber being interposed between and directly connected to each of the process chambers so as to be shared by the process chambers;
substrate transfer apparatus disposed in said transfer passageway, said substrate transfer apparatus having a working envelope encompassing said unloading position and said loadlock chamber, wherein said substrate transfer apparatus is operative to receive a substrate from the index station, to load the received substrate into the loadlock chamber, and to unload a substrate from the loadlock chamber; and
a second substrate transfer robot disposed in said loadlock chamber, said second transfer robot having a working envelope encompassing the working envelope of said substrate transfer apparatus and said plurality of process chambers, wherein said second substrate transfer robot is operative to receive a substrate from the substrate transfer apparatus, to load the received substrate into any of the respective process chambers, and to unload a processed substrate from any of the respective process chambers.

13. The multi-chamber system as recited in claim 12, wherein said second substrate transfer robot includes a blade having at least two substrate supports configured to respectively support substrates in the same plane.

14. The multi-chamber system as recited in claim 13, wherein the blade comprises a fixture, and said substrate supports comprise a first substrate support extending from the fixture at one side thereof, and a second substrate support extending from the fixture at another side thereof, said substrate supports being disposed symmetrically with respect to said fixture.

15. The multi-chamber system as recited in claim 12, wherein said substrate transfer apparatus comprises a first substrate transfer robot having a blade comprising at least one substrate support each configured to support a respective substrate, and said second substrate transfer robot has a blade comprising at least one substrate support each configured to support a respective substrate, each said substrate support of said second substrate transfer robot having a shapes that is different from that of a said substrate support of the first substrate transfer robot.

16. The multi-chamber system as recited in claim 15, wherein said second substrate transfer robot has at least two said substrate supports.

17. The multi-chamber system as recited in claim 16, wherein the substrate supports of said second substrate transfer robot are C-shaped.

18. The multi-chamber system as recited in claim 15, wherein said second substrate transfer robot further comprises an elevator operative to move the blade thereof up and down to allow the first and second substrate transfer robots to directly transfer a substrate therebetween.

19. The multi-chamber system as recited in claim 15, wherein the second substrate transfer robot comprises:
a base,
a first arm having a rear end and a front end, the rear end being connected to said base, and said first arm being supported so as to be rotatable in a horizontal plane about said rear end thereof,
a second arm having a front end and a rear end, the rear end of the second arm being connected to the front end of said first arm, and said second arm being supported so as to be rotatable in a horizontal plane, and
a blade connected to the front end of said second arm and supported so as to be rotatable in a horizontal plane, said blade having at least two substrate supports configured to respectively support substrates in the same plane.

20. The multi-chamber system as recited in claimed 19, wherein the first transfer robot further comprises:
an arm actuator supporting said first arm at said rear end thereof, operatively connected to said first and second arms so as to rotate said arms about the rear ends thereof, respectively, and operatively connected to said blade so as to rotate so blade relative to said second arm,
a first joint rotatably supporting the first arm at said rear end thereof, a second joint connecting the rear end of said second arm to the front end of said first arm and rotatably supporting the second arm at said rear end thereof, a third joint connecting said blade and the front end of said second arm and rotatably supporting said blade at the front end of said second arm, and
timing pulleys timing belts connecting said arm actuator to said joints.
